(19) United States
(12) Patent Application Publication
(10) Pub. No.: US 2008/0075006 A1
(43) Pub. Date: Mar. 27, 2008

(54) Wireless Resource Allocating System, Wireless Control Station, Wireless Resource Allocating Method For Use Therein, And Its Program

(75) Inventor: Motoki Morita, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: Nec Corporation, Minato-ku (JP)

(21) Appl. No.: 11/813,562

(22) PCT Filed: Jan. 19, 2006
(86) PCT No.: PCT/JP2006/300693

§ 371 Date: Jul. 9, 2007

(30) Foreign Application Priority Data
Jan. 20, 2005 (JP) 2005-012189

(51) Int. Cl. H04L 12/56; H04J 13/00; H04Q 7/36; H04Q 7/38

(52) U.S. Cl. 370/232

(57) ABSTRACT

There is provided a wireless control station which is capable of reducing delay in transmitting data.

When initial transmission rate allocator 12 receives an individual wireless link establishing request from a mobile station, initial transmission rate allocator 12 asks minimum transmission rate user number measurer 13 for the number of packet users who are using a minimum transmission rate. If the reported number of minimum transmission rate users is equal to or smaller than a predetermined threshold, then initial transmission rate allocator 12 sets an initial transmission rate to a value smaller than a maximum value taking into consideration a request from a minimum transmission rate user to switch to a higher transmission rate. After the initial transmission rate is established, wireless resource allocator 14 establishes an individual wireless link at the established initial transmission rate if the load reported from load measurer 15 is equal to or smaller than a predetermined threshold.

### TECHNICAL FIELD

The present invention relates to a wireless resource allocating system, a wireless control station, a wireless resource allocating method for use therein, and its program, and more particularly to a wireless resource allocating method for selecting an initial transmission rate depending on traffic.

### BACKGROUND ART

W-CDMA (Wideband-Code Division Multiple Access) wireless communication processes employ spread codes that are included among wireless resources. The spread codes are correlated to a transmission rate such that more spread codes are consumed as the transmission rate becomes higher.

For starting packet communication between a wireless base station and a mobile station, an individual wireless link is established. Spread codes are statically or dynamically divided between packet users. When spread codes are statically divided, a transmission rate is determined in view of the load situation, and the determined transmission rate will not be changed. When spread codes are dynamically divided, the transmission rate can be changed (see, for example, Non-patent Document 1).

According to a process of changing the transmission rate, if the amount of data exceeds a certain threshold continuously for a certain time while a certain transmission rate is being used, then the transmission rate is increased, and if the amount of data is equal to or lower than another certain threshold continuously for a certain time, then the transmission rate is lowered. Whether the transmission rate is to be increased or not is determined by comparing the load situation in a wireless interval with a predetermined threshold. The load situation in the wireless interval corresponds to how spread codes as wireless resources and the transmission power of wireless base stations are consumed (see, for example, Non-patent Document 2).

Non-patent Document 1: “WCDMA FOR UNITS Revised edition” edited by Harri Holma and Antti Toskala, Finland, 2001, pp. 221-224

Non-patent Document 2: “W-CDMA mobile communication system” supervised by Keiji Tachikawa, Maruzen, Jun. 25, 2001, pp. 171-174, 193-194

### DISCLOSURE OF THE INVENTION

According to the conventional wireless resource allocating method described above, when a transmission rate is determined depending on the load situation, if the load is high, a few packet users use a high transmission rate, and if the load is low, many packet users use a low transmission rate. After a transmission rate has been allocated, the difference between the loads is small.

According to the conventional wireless resource allocating method, therefore, it is difficult to judge the load situation, and a transmission rate cannot be selected depending on the situation. According to the conventional wireless resource allocating method, if a low transmission rate has been allocated, then it is necessary that an amount of data continuously exceeds a certain threshold for a certain time in order to switch from the low transmission rate to a higher transmission rate. Since it takes a certain time to switch to the higher transmission rate, the delay in transmitting data is large.

According to the conventional wireless resource allocating method, when a high transmission rate is allocated to a packet user who requests a high transmission rate, a new individual wireless link cannot be established for this packet user, and when a high transmission rate is allocated to a packet user who establishes a new individual wireless link, transmission rates cannot be changed for a packet user who requests a high transmission rate. Therefore, wireless resources are not equally distributed between a packet user who requests a high transmission rate and a packet user who establishes a new individual wireless link.

It is an object of the present invention to provide a wireless resource allocating system, a wireless control station, a wireless resource allocating method for use therein, and its program which are capable of reducing a delay in transmitting data.

Another object of the present invention is to provide a wireless resource allocating system, a wireless control station, a wireless resource allocating method for use therein, and its program which are capable of equally distributing wireless resources.

According to the present invention, there is provided a wireless resource allocating system for establishing an individual wireless link to start packet communications between a wireless base station and a mobile station and for selecting an initial transmission rate that is dependent on traffic between the wireless base station and the mobile station, comprising an initial transmission rate allocating means for selecting the initial transmission rate based on the number of users whose transmission rates are equal to or smaller than a predetermined value.

According to the present invention, there is also provided, in a system for establishing an individual wireless link to start packet communications between a wireless base station and a mobile station, a wireless control station for selecting an initial transmission rate that is dependent on traffic between the wireless base station and the mobile station, comprising an initial transmission rate allocating means for selecting the initial transmission rate based on the number of users whose transmission rates are equal to or smaller than a predetermined value.

According to the present invention, there is further provided, in a system for establishing an individual wireless link to start packet communications between a wireless base station and a mobile station, a wireless resource allocating method for controlling a wireless control station to select an initial transmission rate that is dependent on traffic between the wireless base station and the mobile station, wherein the wireless control station performs a process of selecting the initial transmission rate based on the number of users whose transmission rates are equal to or smaller than a predetermined value.

According to the present invention, there is provided, in a system for establishing an individual wireless link to start packet communications between a wireless base station and a mobile station, a program that comprises a wireless resource allocating method for controlling a wireless control station to select an initial transmission rate depending on traffic between the wireless base station and the mobile station, wherein the program controls a computer of the wireless control station to perform a process of selecting the initial transmission rate based on the number of users whose transmission rates are equal to or smaller than a predetermined value.

The wireless resource allocating method according to the present invention has a minimum transmission rate user number measurer for measuring, for each wireless area, the number of packet users who are using a minimum transmission rate allocated due to the shortage of a certain wireless resource, and an initial transmission rate allocator for determining an initial transmission rate. When an individual wireless link is to be established, the initial transmission rate allocator operates to allocate an initial transmission rate based on a measurement report from the minimum transmission rate user number measurer.

The wireless resource allocating method according to the present invention, which is arranged as described above, can solve the above problems by establishing an individual wireless link based on a wireless resource request situation such as the establishment of an individual wireless link and the switching between transmission rates.

In other words, with the wireless resource allocating method according to the present invention, when an individual wireless link is to be established, a high initial transmission rate is allocated when there is no packet user requesting a high transmission rate. Therefore, a delay in transmitting data can be reduced.

With the wireless resource allocating method according to the present invention, furthermore, a wireless resource is allocated using, as a guide, the number of packet users who are using the minimum transmission rate allocated due to the shortage of a certain wireless resource and who request switching to a higher transmission rate. Consequently, if such a packet user is present, then in view of the allocation of a higher transmission rate to the packet user, the initial transmission rate allocated to a packet user who requests that a new individual wireless link be established can be lowered. As a result, wireless resources can be equally distributed.

The wireless resource allocating method according to the present invention is capable of reducing delay in transmitting data by being arranged and operated as described below.

Another wireless resource allocating method according to the present invention is capable of realizing a uniform distribution of wireless resources by being arranged and operated as described below.

### BRIEF DESCRIPTION OF THE DRAWINGS

FIG. 1 is a block diagram of an arrangement of a mobile communication system according to an exemplary embodiment of the present invention;

FIG. 2 is a block diagram of an arrangement of a wireless resource allocating function part of a wireless control station according to a first embodiment of the present invention;

FIG. 3 is a flowchart of a wireless resource allocating operation sequence of the wireless control station according to the first embodiment of the present invention;

FIG. 4 is a block diagram of an arrangement of a wireless resource allocating function part of a wireless control station according to a second embodiment of the present invention;

FIG. 5 is a flowchart of a wireless resource allocating operation sequence of the wireless control station according to the second embodiment of the present invention;

FIG. 6 is a flowchart of a wireless resource allocating operation sequence of a wireless control station according to a third embodiment of the present invention;

FIG. 7 is a flowchart of a wireless resource allocating operation sequence of a wireless control station according to a fourth embodiment of the present invention;

FIG. 8 is a diagram illustrative of a wireless resource allocating process according to a fifth embodiment of the present invention; and

FIG. 9 is a diagram illustrative of the wireless resource allocating process according to the fifth embodiment of the present invention.

### DESCRIPTION OF REFERENCE CHARACTERS

1, 4 wireless control station

2a, 2b base station

3 mobile station

10, 40 CPU (wireless resource allocating function part)

11 individual wireless link establishing request receiver

12 initial transmission rate allocator

13 minimum transmission rate user number measurer

14 wireless resource allocator

15 load measurer

16 rate switcher

17 wireless resource releaser

18, 41 recording medium

100 network

201, 202 wireless region

### BEST MODE FOR CARRYING OUT THE INVENTION

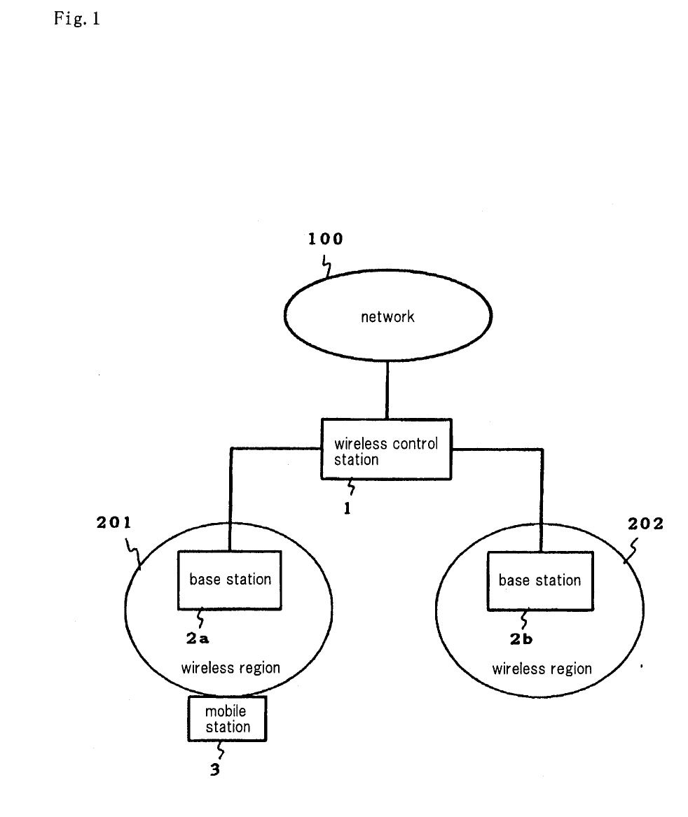

An exemplary embodiment of the present invention will be described below with reference to the drawings. FIG. 1 is a block diagram of an arrangement of a mobile communication system according to an exemplary embodiment of the present invention. The mobile communication system according to the exemplary embodiment of the present invention employs a W-CDMA (Wideband-Code Division Multiple Access) mobile communication process as a wireless access process.

The mobile communication system comprises wireless control station 1 directly connected to wired network 100, base stations 2a, 2b connected to wireless control station 1, and mobile station 3 for communicating with either one of base stations 2a, 2b. In FIG. 1, one mobile station 3 is shown as belonging to wireless area 201 that is formed by base station 2a. Though only two base stations 2a, 2b are shown in FIG. 1, three or more base stations may be used. Though wireless areas 201, 202 are formed respectively by base stations 2a, 2b, one base station may form a plurality of wireless areas. Furthermore, a plurality of mobile stations 3 may belong to one wireless area.

Base stations 2a, 2b are of an identical arrangement and form respective wireless areas 201, 202. Base stations 2a, 2b are capable of communicating with mobile station 3 in respective wireless areas 201, 202. Conversely, wireless areas 201, 202 represent areas wherein base stations 2a, 2b can perform wireless communications with mobile station 3.

When mobile station 3 is to connect to base stations 2a, 2b, mobile station 3 sends an individual wireless link establishing request to wireless control station 1. Wireless control station 1, which controls base stations 2a, 2b to set a wireless link to mobile station 3, receives the individual wireless link establishing request from mobile station 3.

Wireless control station 1 includes a minimum transmission rate user number measurer for measuring, for each of wireless areas 201, 202, the number of packet users who are using the minimum transmission rate allocated due to the shortage of a certain wireless resource, and includes an initial transmission rate allocator for determining the initial transmission rate. For establishing an individual wireless link, wireless control station 1 operates to allocate an initial transmission rate based on a measurement report from the minimum transmission rate user number measurer.

According to the exemplary embodiment of the present invention, wireless control station 1 has the above arrangement and solves the above problems by establishing an individual wireless link at an initial transmission rate based on a wireless resource request situation such as the establishment of an individual wireless link and the switching between transmission rates.

In other words, according to the exemplary embodiment of the present invention, when an individual wireless link is to be established, a high initial transmission rate is allocated when there is no packet user requesting a high transmission rate. Therefore, delay in transmitting data can be reduced.

According to the exemplary embodiment of the present invention, furthermore, a wireless resource is allocated using, as a guide, the number of packet users who are using a minimum transmission rate allocated due to the shortage of a certain wireless resource and who request switching to a higher transmission rate. Consequently, if such a packet user is present, then in view of the allocation of a higher transmission rate to the packet user, the initial transmission rate allocated to a packet user who requests that a new individual wireless link to be established can be lowered. As a result, wireless resources can be equally distributed.

### Embodiment 1

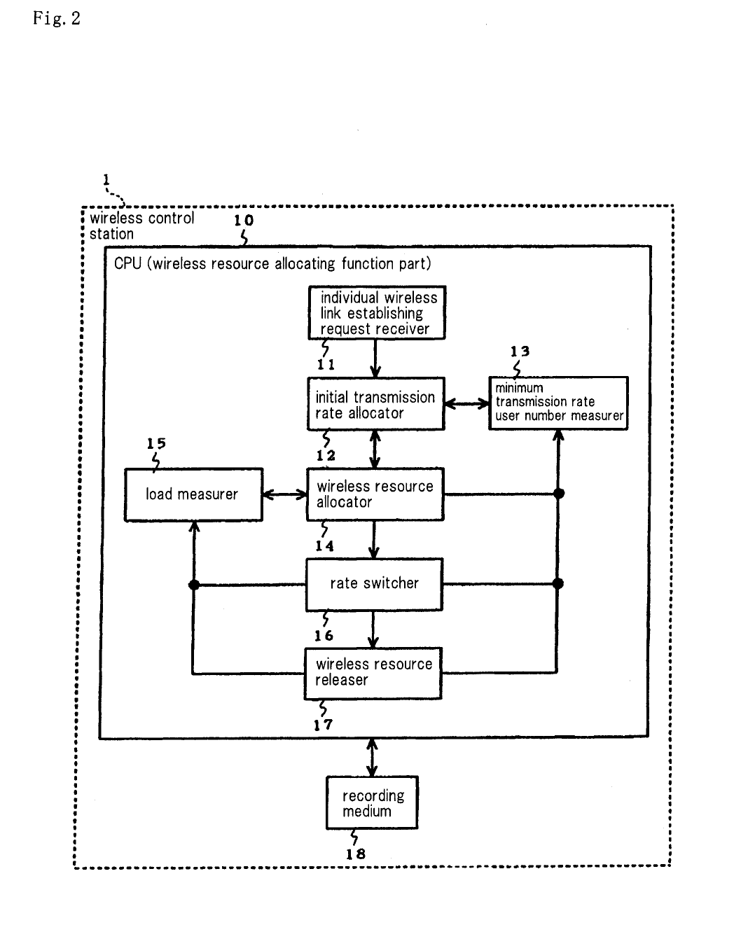

FIG. 2 is a block diagram of an arrangement of a wireless resource allocating function part of a wireless control station according to a first embodiment of the present invention. The arrangement of a mobile communication system according to the first embodiment of the present invention is the same as the arrangement of the mobile communication system according to the exemplary embodiment of the present invention shown in FIG. 1, and will not be described below.

In FIG. 1, wireless control station 1 comprises CPU (Central Processing unit, wireless resource allocating function part) 10 and recording medium 18 for storing a program to be executed by CPU 10. CPU 10 comprises individual wireless link establishing request receiver 11, initial transmission rate allocator 12, minimum transmission rate user number measurer 13, wireless resource allocator 14, load measurer 15, rate switcher 16, and wireless resource releaser 17.

Individual wireless link establishing request receiver 11 receives an individual wireless link establishing request from mobile station 3, and initial transmission rate allocator 12 determines an initial transmission rate to be used in a wireless link. Minimum transmission rate user number measurer 13 measures, for each of wireless areas 201, 202, the number of packet users who are being connected at a minimum transmission rate which is equal to or lower than a predetermined value.

Wireless resource allocator 14 allocates a wireless resource corresponding to the transmission rate, and load measurer 15 measures loads on wireless areas 201, 202. Rate switcher 16 switches between transmission rates, and wireless resource releaser 17 releases the wireless resource after the transmission of data is finished.

The components of CPU 10 generally operate as follows: Individual wireless link establishing request receiver 11, which has not established a wireless link, receives an individual wireless link establishing request from mobile station 3 which requests that a new individual wireless link be established. When the individual wireless link establishing request is input, initial transmission rate allocator 12 asks minimum transmission rate user number measurer 13 for the number of packet users who are being connected at a minimum transmission rate, and determines an initial transmission rate based on a report from minimum transmission rate user number measurer 13.

Initial transmission rate allocator 12 stores rate 0, rate 1, and rate 2 which represent the values of initial transmission rates that can be allocated. The values of initial transmission rates are related to each other as rate 0<rate 1<rate 2 with rate 0 being a minimum transmission rate. Rate 0 is selected as an initial transmission rate only when initial transmission rate allocator 12 receives a report from wireless resource allocator 14 indicating that there is a wireless resource shortage for allocating a determined initial transmission rate. Initial transmission rate allocator 12 also stores threshold R1 for the number of minimum transmission rate users for determining an initial transmission rate.

Minimum transmission rate user number measurer 13 measures the number of packet users which have selected rate 0 as an initial transmission rate. Minimum transmission rate user number measurer 13 can measure the number of such packet users by adding and subtracting 1. Minimum transmission rate user number measurer 13 adds 1 when it receives a report from wireless resource allocator 14 indicating that rate 0 is allocated as an initial transmission rate. Minimum transmission rate user number measurer 13 subtracts 1 when it receives a report from rate switcher 16 or wireless resource releaser 17 indicating that a packet user who used rate 0 an initial transmission rate has stopped using rate 0.

Wireless resource allocator 14 allocates a spread code and an electric power level which correspond to the initial transmission rate determined by initial transmission rate allocator 12 to an individual wireless link. Wireless resource allocator 14 determines whether a spread code and an electric power level can actually be allocated or not, based on the load reported from load measurer 15. Specifically, if the load is equal to or less than predetermined threshold L1, then wireless resource allocator 14 permits a spread code and an electric power level to be allocated.

Load measurer 15 measures the loads on wireless areas 201, 202. The load on each wireless area is determined from a spread ratio and a required reception quality. When load measurer 15 receives a report indicating that a wireless resource has been newly allocated to an individual wireless link, from wireless resource allocator 14 or rate switcher 16, load measurer 15 adds the load of the wireless link. When load measurer 15 receives a report indicating that a wireless resource is released, from wireless resource releaser 17 or rate switcher 16, load measurer 15 subtracts the load of the wireless link.

Rate switcher 16 performs rate switching, one step at a time, between rate 0, . . . , rate i, . . . , rate 1, . . . , rate j, . . . , rate 2 that can be used for wireless areas 201, 202. These rates are related to each other as rate 0<rate i<rate 1<rate j<rate 2 where i, j represent any optional letters. Rate switching is performed such that if the amount of data exceeds a certain threshold continuously for a certain time while a certain transmission rate is being used, then the transmission rate is increased, and if the amount of data is equal to or lower than another certain threshold continuously for a certain time, then the transmission rate is lowered.

Wireless resource releaser 17 releases a wireless resource allocated to an individual wireless link after the transmission of data is finished.

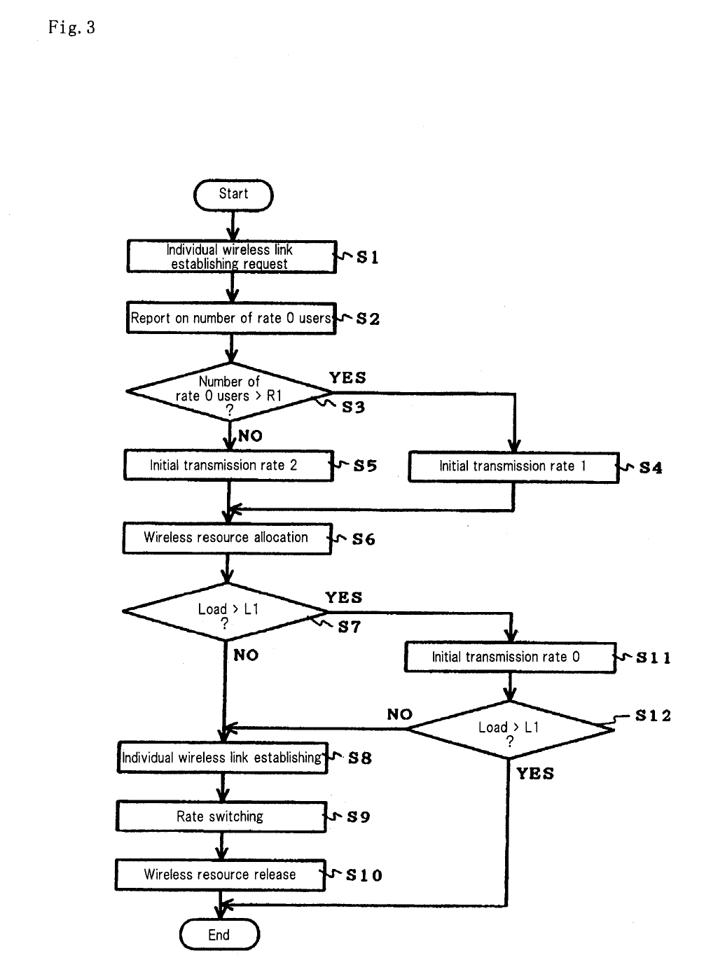

FIG. 3 is a flowchart of a wireless resource allocating operation sequence of wireless control station 1 according to the first embodiment of the present invention. The wireless resource allocating operation sequence of wireless control station 1 according to the first embodiment of the present invention will be described below with reference to FIGS. 1 through 3. The operation sequence shown in FIG. 3 is performed when CPU 10 executes the program stored in recording medium 18.

Initial transmission rate allocator 12 is supplied with an individual wireless link establishing request from mobile station 3 (step S1 in FIG. 3). When initial transmission rate allocator 12 receives a report on the number of packet users who are using rate 0 (minimum transmission rate) from minimum transmission rate user number measurer 13 (step S2 in FIG. 3) upon reception of the individual wireless link establishing request, initial transmission rate allocator 12 compares the number of rate 0 users with threshold R1 (step S3 in FIG. 3).

If the number of rate 0 users exceeds threshold R1, then initial transmission rate allocator 12 determines rate 1 as an initial transmission rate (step S4 in FIG. 3). If the number of rate 0 users is equal to or smaller than threshold R1, then initial transmission rate allocator 12 determines rate 2 (maximum transmission rate) as an initial transmission rate (step S5 in FIG. 3).

Initial transmission rate allocator 12 inputs the determined initial transmission rate to wireless resource allocator 14 (step S6 in FIG. 3). Wireless resource allocator 14 compares the measured value of the load reported from load measurer 15 with threshold L1 (step S7 in FIG. 3). To the measured value of the load, there has been added the load of an individual wireless link that is established.

If the load is equal to or smaller than threshold L1, then wireless resource allocator 14 permits a wireless resource to be allocated to an individual wireless link (step S8 in FIG. 3). If the load is in excess of threshold L1, then wireless resource allocator 14 sets the initial transmission rate to rate 0 (step S11 in FIG. 3), and again compares the measured value of the load with threshold L1 (step S12 in FIG. 3). At this time, the load includes the load to which the rate 0 has been added.

If the load is equal to or smaller than threshold L1, then wireless resource allocator 14 permits a wireless resource to be allocated to an individual wireless link (step S8 in FIG. 3). If the load is in excess of threshold L1, then wireless resource allocator 14 does not establish an individual wireless link, and the operation sequence is put to an end.

After the individual wireless link is established, rate switcher 16 switches between rates depending on the amount of data to be transmitted (step S9 in FIG. 3). When transmission of all data is finished, wireless resource releaser 17 releases the wireless resource allocated to the individual wireless link (step S10 in FIG. 3).

According to the present embodiment, since a maximum transmission rate is allocated as an initial transmission rate, a delay involved in switching to the maximum transmission rate is eliminated, and hence a delay in transmitting data is reduced.

According to the present embodiment, furthermore, inasmuch as an initial transmission rate is determined based on a wireless resource request situation, using, as a guide, the number of packet users to whom a minimum transmission rate has been allocated due to the shortage of a wireless resource, wireless resources can be equally distributed between a packet user who requests a new individual wireless link to be established and a packet user who requests switching to a higher transmission rate.

### Embodiment 2

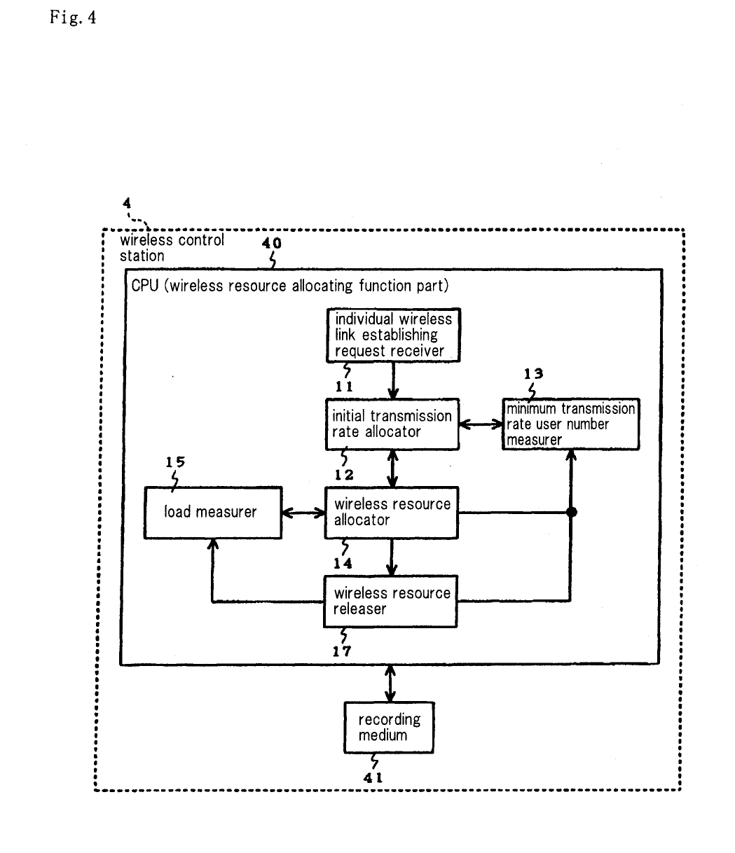

FIG. 4 is a block diagram of an arrangement of a wireless resource allocating function part of a wireless control station according to a second embodiment of the present invention. The arrangement of a mobile communication system according to the second embodiment of the present invention is the same as the arrangement of the mobile communication system according to the exemplary embodiment of the present invention shown in FIG. 1, and will not be described below.

In FIG. 4, wireless control station 4 comprises CPU (Central Processing unit, wireless resource allocating function part) 40 and recording medium 41 for storing a program to be executed by CPU 40. The arrangement of CPU 40 is similar to the arrangement of CPU 10 of wireless control station 1 according to the first embodiment shown in FIG. 2 except that CPU 40 is free of rate switcher 16. Those parts of CPU 40 which are identical to those of CPU 10 are denoted by identical reference numerals.

CPU 40 of wireless control station 4 according to the second embodiment comprises individual wireless link establishing request receiver 11, initial transmission rate allocator 12, minimum transmission rate user number measurer 13, wireless resource allocator 14, load measurer 15, and wireless resource releaser 17. After a wireless link is established, wireless control station 4 according to the second embodiment fixes a transmission rate and does not change the transmission rate. According to the present embodiment, therefore, there is no packet user who would request switching to a higher transmission rate.

In the present embodiment, minimum transmission rate user number measurer 13 operates differently from minimum transmission rate user number measurer 13 according to the first embodiment. Specifically, minimum transmission rate user number measurer 13 subtracts 1 only when it receives a report from wireless resource releaser 17 indicating that a packet user who used rate 0 as an initial transmission rate has ended using rate 0.

In the present embodiment, load measurer 15 operates differently from load measurer 15 according to the first embodiment. Specifically, the load measurer 15 adds the load of a wireless link only when it receives a report from wireless resource allocator 14 indicating that a wireless resource has been newly allocated to an individual wireless link.

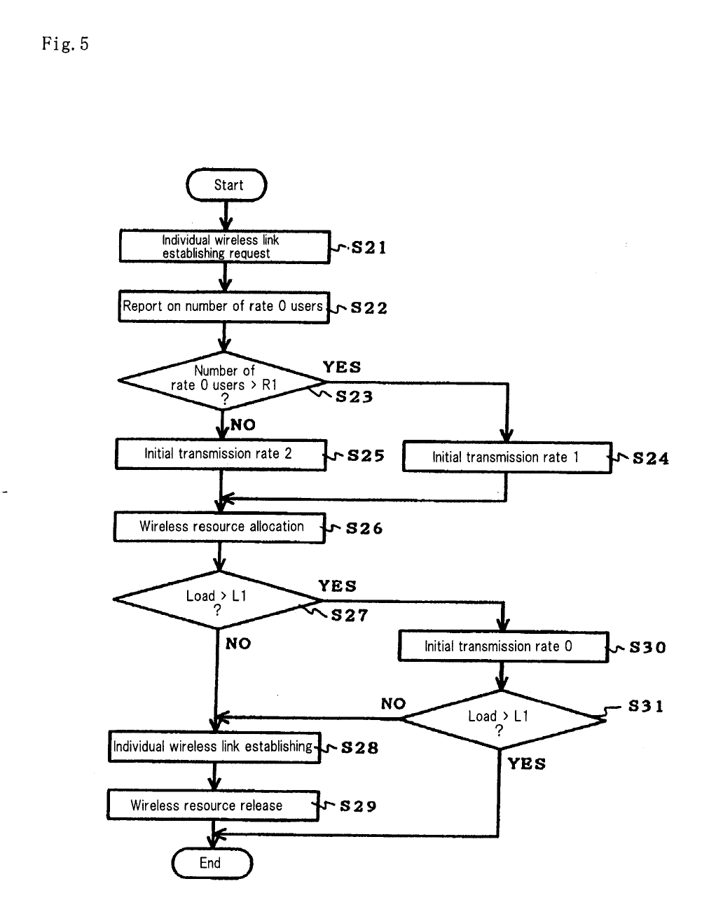

FIG. 5 is a flowchart of a wireless resource allocating operation sequence of wireless control station 4 according to the second embodiment of the present invention. The wireless resource allocating operation sequence of wireless control station 4 according to the second embodiment of the present invention will be described below with reference to FIGS. 1, 4, and 5. The operation sequence shown in FIG. 5 is performed when CPU 40 executes the program stored in recording medium 41.

Initial transmission rate allocator 12 is supplied with an individual wireless link establishing request from mobile station 3 (step S21 in FIG. 5). When initial transmission rate allocator 12 receives a report on the number of packet users who are using rate 0 (minimum transmission rate) from minimum transmission rate user number measurer 13 (step S22 in FIG. 5) upon receipt of an individual wireless link establishing request, initial transmission rate allocator 12 compares the number of rate 0 users with threshold R1 (step S23 in FIG. 5).

If the number of rate 0 users exceeds threshold R1, then initial transmission rate allocator 12 determines rate 1 as an initial transmission rate (step S24 in FIG. 3). If the number of rate 0 users is equal to or smaller than threshold R1, then initial transmission rate allocator 12 determines rate 2 (maximum transmission rate) as an initial transmission rate (step S25 in FIG. 5).

Initial transmission rate allocator 12 inputs the determined initial transmission rate to wireless resource allocator 14 (step S26 in FIG. 5). Wireless resource allocator 14 compares the measured value of the load reported from load measurer 15 with threshold L1 (step S27 in FIG. 5). To the measured value of the load, there has been added the load of an individual wireless link to be established.

If the load is equal to or smaller than threshold L1, then wireless resource allocator 14 permits a wireless resource to be allocated to an individual wireless link (step S28 in FIG. 5). If the load is in excess of threshold L1, then wireless resource allocator 14 sets the initial transmission rate to rate 0 (step S30 in FIG. 5), and again compares the measured value of the load with threshold L1 (step S31 in FIG. 5). At this time, the load includes the load to which the rate 0 has been added.

If the load is equal to or smaller than threshold L1, then wireless resource allocator 14 permits a wireless resource to be allocated to an individual wireless link (step S28 in FIG. 5). If the load is in excess of threshold L1, then wireless resource allocator 14 does not establish an individual wireless link, and the operation sequence is put to an end.

When the transmission of all data is finished, wireless resource releaser 17 releases the wireless resource allocated to the individual wireless link (step S29 in FIG. 5).

According to the present embodiment, since transmission rates are used from a higher transmission rate, delay in transmitting data is reduced.

### Embodiment 3

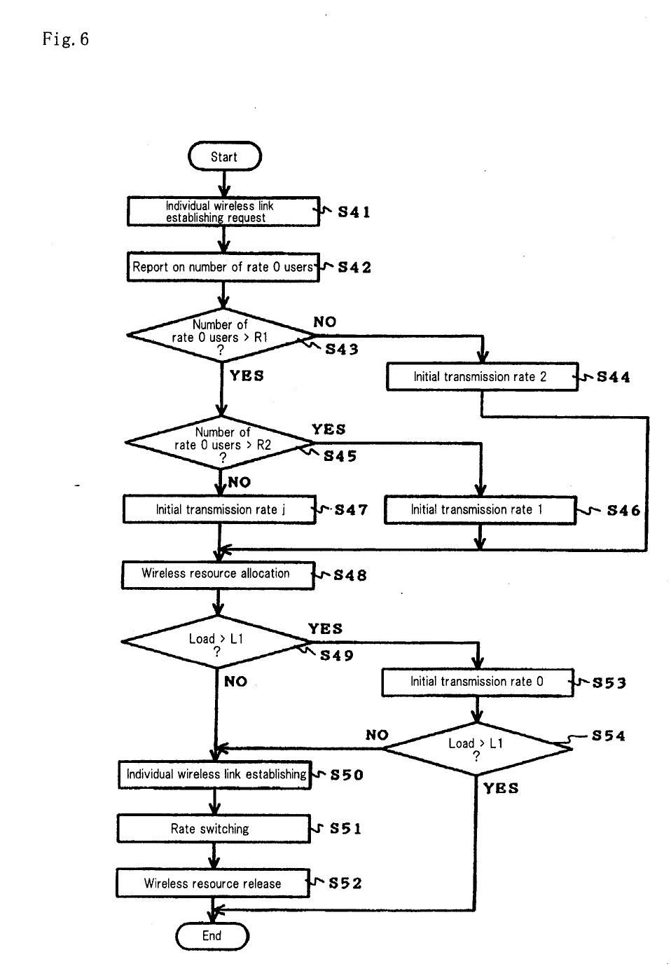

FIG. 6 is a flowchart of a wireless resource allocating operation sequence of a wireless control station according to a third embodiment of the present invention. The arrangement of a mobile communication system according to the third embodiment of the present invention is the same as the arrangement of the mobile communication system according to the exemplary embodiment of the present invention shown in FIG. 1, and the arrangement of the wireless control station according to the third embodiment of the present invention is the same as the arrangement of wireless control station 1 according to the first embodiment of the present invention shown in FIG. 2. Therefore, these arrangements will not be described below.

The wireless resource allocating operation sequence of wireless control station 1 according to the third embodiment of the present invention will be described below with reference to FIGS. 1, 2, and 6. The operation sequence shown in FIG. 6 is performed when CPU 10 executes the program stored in recording medium 18. However, the present embodiment is different from the first embodiment of the present invention in that initial transmission rate allocator 12 shown in FIG. 2 stores any optional rate j in addition to rate 0, rate 1, and rate 2 as initial transmission rates, and also stores R1, R2 (R<R2) as thresholds for the number of minimum transmission rate users.

Initial transmission rate allocator 12 is supplied with an individual wireless link establishing request from mobile station 3 (step S41 in FIG. 6). When initial transmission rate allocator 12 receives a report on the number of packet users who are using rate 0 (minimum transmission rate) from minimum transmission rate user number measurer 13 (step S42 in FIG. 6) upon receipt of an individual wireless link establishing request, initial transmission rate allocator 12 compares the number of rate 0 users with threshold R1 (step S43 in FIG. 6).

If the number of rate 0 users exceeds threshold R1, then initial transmission rate allocator 12 compares the number of rate 0 users with another threshold R2 (step S45 in FIG. 6). If the number of rate 0 users exceeds another threshold R2, then initial transmission rate allocator 12 determines rate 1 as an initial transmission rate (step S46 in FIG. 6). If the number of rate 0 users is equal to or smaller than another threshold R2, then initial transmission rate allocator 12 determines rate j as an initial transmission rate (step S47 in FIG. 6).

If the number of rate 0 users is equal to or smaller than threshold R1, then initial transmission rate allocator 12 determines rate 2 (maximum transmission rate) as an initial transmission rate (step S44 in FIG. 6).

Initial transmission rate allocator 12 inputs the determined initial transmission rate to wireless resource allocator 14 (step S48 in FIG. 6). Wireless resource allocator 14 compares the measured value of the load reported from load measurer 15 with threshold L1 (step S49 in FIG. 6). To the measured value of the load, there has been added the load of an individual wireless link to be established.

If the load is equal to or smaller than threshold L1, then wireless resource allocator 14 permits a wireless resource to be allocated to an individual wireless link (step S50 in FIG. 6). If the load is in excess of threshold L1, then wireless resource allocator 14 sets the initial transmission rate to rate (step S53 in FIG. 6), and again compares the measured value of the load with threshold L1 (step S54 in FIG. 6). At this time, the load includes the load to which the rate 0 has been added.

If the load is equal to or smaller than threshold L1, then wireless resource allocator 14 permits a wireless resource to be allocated to an individual wireless link (step S50 in FIG. 6). If the load is in excess of threshold L1, then wireless resource allocator 14 does not establish an individual wireless link, and the operation sequence is put to an end.

After the individual wireless link is established, rate switcher 16 switches between rates depending on the amount of data to be transmitted (step S51 in FIG. 6). When the transmission of all data is finished, wireless resource releaser 17 releases the wireless resource allocated to the individual wireless link (step S52 in FIG. 6).

In the present embodiment, it has been described that the number of initial transmission rates that can be allocated is 4 and the number of thresholds for the number of minimum transmission rate users is 2. However, the number of initial transmission rates and the number of thresholds for the number of minimum transmission rate users may be set respectively to the number of rates that can be used in a wireless area and the number of rates that can be used in a wireless area—2 at maximum.

According to the present embodiment, since transmission rates are used successively from a higher transmission rate, delay in transmitting data is further reduced compared with the first embodiment of the present invention described above.

### Embodiment 4

FIG. 6 is a flowchart of a wireless resource allocating operation sequence of a wireless control station according to a fourth embodiment of the present invention. The arrangement of a mobile communication system according to the fourth embodiment of the present invention is the same as the arrangement of the mobile communication system according to the exemplary embodiment of the present invention shown in FIG. 1, and the arrangement of the wireless control station according to the fourth embodiment of the present invention is the same as the arrangement of wireless control station 4 according to the second embodiment of the present invention shown in FIG. 4. Therefore, these arrangements will not be described below.

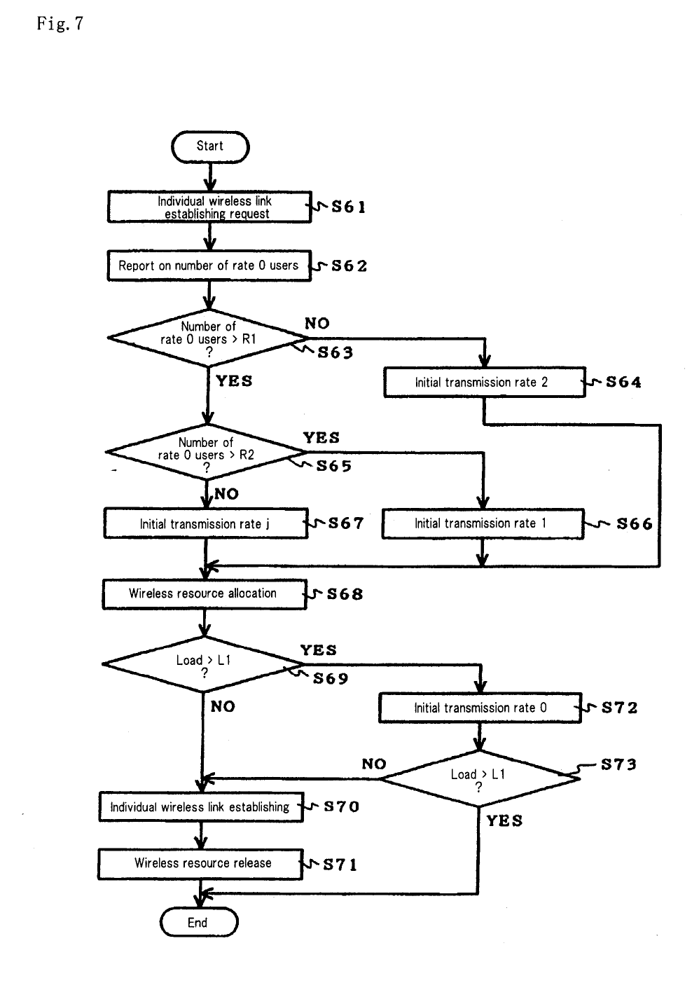

The wireless resource allocating operation sequence of wireless control station 1 according to the fourth embodiment of the present invention will be described below with reference to FIGS. 1, 4, and 7. The operation sequence shown in FIG. 7 is performed when CPU 40 executes the program stored in recording medium 41. However, the present embodiment is different from the second embodiment of the present invention in that initial transmission rate allocator 12 shown in FIG. 2 stores any optional rate j in addition to rate 0, rate 1, and rate 2 as initial transmission rates, and also stores R1, R2 (R1<R2) as thresholds for the number of minimum transmission rate users.

Initial transmission rate allocator 12 is supplied with an individual wireless link establishing request from mobile station 3 (step S61 in FIG. 7). When initial transmission rate allocator 12 receives a report on the number of packet users who are using rate 0 (minimum transmission rate) from minimum transmission rate user number measurer 13 (step S62 in FIG. 7) upon receipt of an individual wireless link establishing request, initial transmission rate allocator 12 compares the number of rate 0 users with threshold R1 (step S63 in FIG. 7).

If the number of rate 0 users exceeds threshold R1, then initial transmission rate allocator 12 compares the number of rate 0 users with another threshold R2 (step S65 in FIG. 7). If the number of rate 0 users exceeds another threshold R2, then initial transmission rate allocator 12 determines rate 1 as an initial transmission rate (step S66 in FIG. 7). If the number of rate 0 users is equal to or smaller than another threshold R2, then initial transmission rate allocator 12 determines rate j as an initial transmission rate (step S67 in FIG. 7).

If the number of rate 0 users is equal to or smaller than threshold R1, then initial transmission rate allocator 12 determines rate 2 (maximum transmission rate) as an initial transmission rate (step S64 in FIG. 7).

Initial transmission rate allocator 12 inputs the determined initial transmission rate to wireless resource allocator 14 (step S68 in FIG. 7). Wireless resource allocator 14 compares the measured value of the load reported from load measurer 15 with threshold L1 (step S69 in FIG. 7). To the measured value of the load, there has been added the load of an individual wireless link to be established.

If the load is equal to or smaller than threshold L1, then wireless resource allocator 14 permits a wireless resource to be allocated to an individual wireless link (step S70 in FIG. 7). If the load is in excess of threshold L1, then wireless resource allocator 14 sets the initial transmission rate to rate 0 (step S72 in FIG. 7), and again compares the measured value of the load with threshold L1 (step S73 in FIG. 7). At this time, the load includes the load to which the rate 0 has been added.

If the load is equal to or smaller than threshold L1, then wireless resource allocator 14 permits a wireless resource to be allocated to an individual wireless link (step S70 in FIG. 7). If the load is in excess of threshold L1, then wireless resource allocator 14 does not establish an individual wireless link, and the operation sequence is put to an end.

When transmission of all data is finished, wireless resource releaser 17 releases the wireless resource allocated to the individual wireless link (step S71 in FIG. 7).

In the present embodiment, it has been described that the number of initial transmission rates that can be allocated is 4 and the number of thresholds for the number of minimum transmission rate users is 2. However, the number of initial transmission rates and the number of thresholds for the number of minimum transmission rate users may be set respectively to the number of rates that can be used in a wireless area and the number of rates that can be used in a wireless area—2 at maximum.

According to the present embodiment, since transmission rates are used successively from a higher transmission rate, a delay in transmitting data is further reduced compared with the second embodiment of the present invention described above.

### Embodiment 5

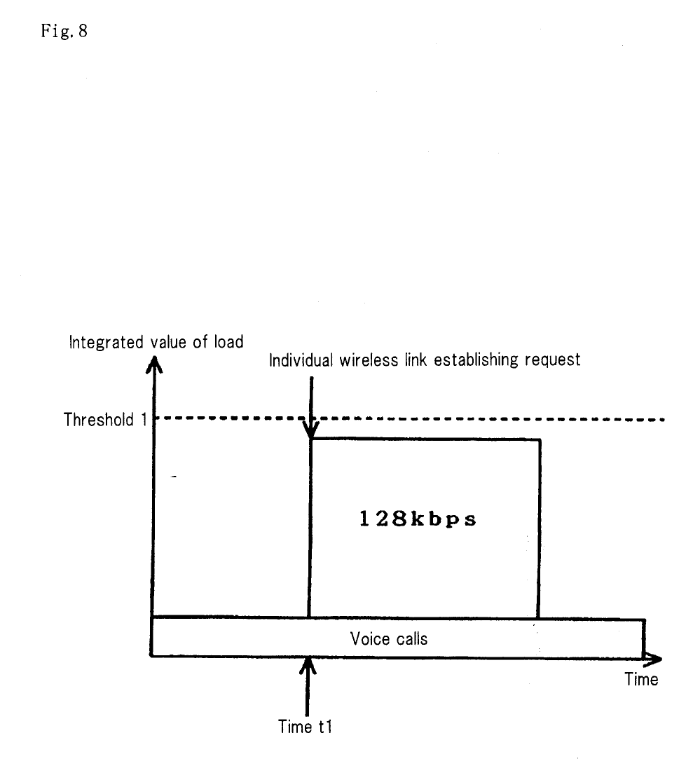

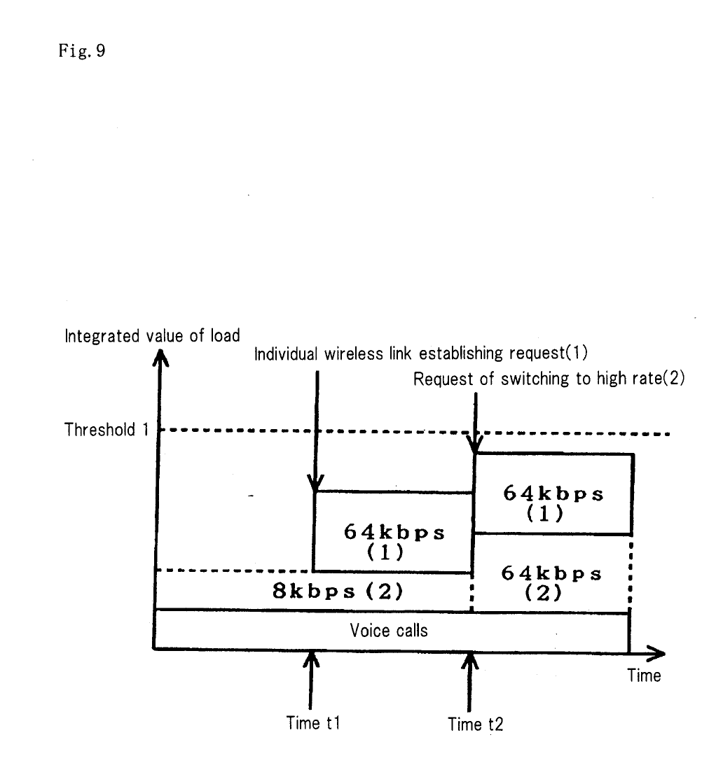

FIGS. 8 and 9 illustrate a wireless resource allocating process according to a fifth embodiment of the present invention. The wireless resource allocating process according to the fifth embodiment of the present invention will be described below with reference to FIGS. 8 and 9. The present embodiment provides a specific account of the first through fourth embodiments described above.

An example in which transmission rates that can be used in wireless areas 201, 202 are 128 kbps, 64 kbps, and 8 kbps and in which threshold R1 is 0 will be described below. At this time rate 0 corresponds to 128 kbps, rate 1 to 64 kbps, and rate 2 to 128 kbps.

Initial transmission rate allocator 12 stores the values of 128 kbps, 64 kbps, and 8 kbps and R1=0, and minimum transmission rate user number measurer 13 measures the number of packet users to whom the transmission rate of 8 kbps is allocated when there is a shortage of a wireless resource corresponding to 128 kbps or 64 kbps.

In FIG. 8, it is assumed that an individual wireless link establishing request is produced from a mobile station at certain time t1 in a graph having a horizontal axis that represents time and a vertical axis that represents the integrated value of the load. The load can be integrated up to L1 at maximum. It is assumed that only voice calls exist prior to time t1.

In FIG. 8, since the measured value from minimum transmission rate user number measurer 13 is 0, the initial transmission rate for an individual wireless link is determined to be 128 kbps. Even when the load corresponding to 128 kbps is integrated, the integrated value is less than L1. Therefore, an individual wireless link is established at the transmission rate of 128 kbps. According to the present embodiment, therefore, since an individual wireless link can be established at a maximum transmission rate, delay in transmitting data is reduced.

In FIG. 9, it is assumed that there is user (2) having a transmission rate of 8 kbps prior to time t1 when an individual wireless link establishing request is produced from a user (1) in a graph that has a horizontal axis that represents the time and a vertical axis that represents the integrated value of the load. Since the measured value from minimum transmission rate user number measurer 13 is 1 at this time, the initial transmission rate for an individual wireless link is determined to be 64 kbps. Even when the load corresponding to 64 kbps is integrated, the integrated value is less than L1. Therefore, an individual wireless link is established at the transmission rate of 64 kbps.

Thereafter, at time t2, user (2) requests the transmission rate to switch to 64 kbps. Even when the load corresponding to 8 kbps is subtracted and the load corresponding to 64 kbps is added, the integrated value is less than L1. Consequently, user (2) is permitted to switch the transmission rate to 64 kbps. According to the present embodiment, therefore, wireless resources can be equally distributed even at different times between a user who requests a new individual wireless link to be established and a user who requests switching to a higher transmission rate.

### INDUSTRIAL APPLICABILITY

The present invention is applicable to a wireless resource allocating function in an apparatus for managing wireless resources. The present invention is also applicable to a scheduling function for appropriately allocating a rate to a wireless link.

1. A wireless resource allocating system for establishing an individual wireless link to start packet communications between a wireless base station and a mobile station and for selecting an initial transmission rate depending on traffic between the wireless base station and the mobile station, comprising:
initial transmission rate allocating means for selecting said initial transmission rate based on the number of users whose transmission rates are equal to or smaller than a predetermined value.

2. A wireless resource allocating system according to claim 1, further comprising:
transmission rate user number measuring means for measuring the number of users who are connected at a transmission rate equal to or smaller than said predetermined value;
wherein said initial transmission rate allocating means selects any one rate from among a plurality of prestored initial transmission rates based on a measurement result from said transmission rate user number measuring means.

3. A wireless resource allocating system according to claim 1, further comprising:
rate switching means for switching said transmission rate depending on an amount of data to be transmitted after said individual wireless link is established.

4. A wireless resource allocating system according to claim 1, further comprising:
wireless resource allocating means for allocating a wireless resource corresponding to said initial transmission rate.

5. A wireless resource allocating system according to claim 1, wherein said initial transmission rate allocating means stores a transmission rate which can be used in a wireless area as said initial transmission rate.

6. A wireless resource allocating system according to claim 1, wherein said initial transmission rate allocating means compares the number of users whose transmission rates are equal to or smaller than said predetermined value with a prestored threshold to determine said initial transmission rate.

7. A wireless resource allocating system according to claim 2, wherein said transmission rate user number measuring means measures, for each of wireless areas, the number of users to whom said transmission rate, that is equal to or smaller than said predetermined value, is allocated when a transmission rate that is higher than said predetermined value cannot be allocated due to a wireless resource shortage.

8. A wireless control station for selecting an initial transmission rate depending on traffic between a wireless base station and a mobile station, in a system for establishing an individual wireless link to start packet communications between the wireless base station and the mobile station, comprising:
initial transmission rate allocating means for selecting said initial transmission rate based on the number of users whose transmission rates are equal to or smaller than a predetermined value.

9. A wireless control station according to claim 8, further comprising:
transmission rate user number measuring means for measuring the number of users who are connected at a transmission rate equal to or smaller than said predetermined value;
wherein said initial transmission rate allocating means selects any one rate from among a plurality of prestored initial transmission rates based on a measurement result from said transmission rate user number measuring means.

10. A wireless control station according to claim 8, further comprising:
rate switching means for switching said transmission rate depending on an amount of data to be transmitted after said individual wireless link is established.

11. A wireless control station according to claim 8, further comprising:
wireless resource allocating means for allocating a wireless resource corresponding to said initial transmission rate.

12. A wireless control station according to claim 8, wherein said initial transmission rate allocating means stores a transmission rate which can be used in a wireless area as said initial transmission rate.

13. A wireless control station according to claim 8, wherein said initial transmission rate allocating means compares the number of users whose transmission rates are equal to or smaller than said predetermined value with a prestored threshold to determine said initial transmission rate.

14. A wireless control station according to claim 9, wherein said transmission rate user number measuring means measures, for each of wireless areas, the number of users to whom said transmission rate, that is equal to or smaller than said predetermined value is allocated when a transmission rate that is higher than said predetermined value cannot be allocated due to a wireless resource shortage.

15. A wireless resource allocating method for controlling a wireless control station to select an initial transmission rate depending on traffic between a wireless base station and a mobile station, in a system for establishing an individual wireless link to start packet communications between the wireless base station and the mobile station, wherein
said wireless control station performs a process of selecting said initial transmission rate based on the number of users whose transmission rates are equal to or smaller than a predetermined value.

16. A wireless resource allocating method according to claim 15, wherein said wireless control station performs a process of measuring the number of users who are connected at a transmission rate equal to or smaller than said predetermined value, and, when said wireless control station performs the process of selecting said initial transmission rate, said wireless control station selects any one rate from among a plurality of prestored initial transmission rates based on a measurement result from said process of measuring the number of users.

17. A wireless resource allocating method according to claim 15, wherein said wireless control station performs a process of switching said transmission rate depending on an amount of data to be transmitted after said individual wireless link is established.

18. A wireless resource allocating method according to claim 15, wherein said wireless control station performs a process of allocating a wireless resource corresponding to said initial transmission rate.

19. A wireless resource allocating method according to claim 15, wherein said wireless control station stores a transmission rate which can be used in a wireless area as said initial transmission rate.

20. A wireless resource allocating method according to claim 15, wherein when said wireless control station performs the process of selecting said initial transmission rate, said wireless control station compares the number of users whose transmission rates are equal to or smaller than said predetermined value with a prestored threshold to determine said initial transmission rate.

21. A wireless resource allocating method according to claim 16, wherein said wireless control station measures, for each of wireless areas, the number of users to whom said transmission rate, that is equal to or smaller than said predetermined value, is allocated when a transmission rate that is higher than said predetermined value cannot be allocated due to a wireless resource shortage.

22. A program that comprises a wireless resource allocating method for controlling a wireless control station to select an initial transmission rate depending on traffic between a wireless base station and a mobile station, in a system for establishing an individual wireless link to start packet communications between the wireless base station and the mobile station, wherein
said program controls a computer of said wireless control station to perform a process of selecting said initial transmission rate based on the number of users whose transmission rates are equal to or smaller than a predetermined value.
